(19) United States
(12) Patent Application Publication
(10) Pub. No.: US 2008/0232945 A1
(43) Pub. Date: Sep. 25, 2008

(54) Work Positioning Device

(76) Inventors: Victor Holodryga, Brandon (CA); Michael Dunham, Waterdown (CA)

Correspondence Address: ADE & COMPANY INC., 2157 Henderson Highway, WINNIPEG, MB, R2G1P9, CA

(21) Appl. No.: 11/688,651

(22) Filed: Mar. 20, 2007

(51) Int. Cl. B25J 15/00

(52) U.S. Cl. 414/783

(57) ABSTRACT

A work positioning device has a base and first and second support arms pivotally supported on the base. Each support arm has a primary supporting surface, upon which the object is arranged to be supported, and which is pivotal between an upright position in which the primary supporting surface extends generally upward and a lateral position in which the primary supporting surface extends generally laterally. First and second actuators are coupled between the base and the first and second support arms respectively to displace the first and second support arms between their upright and lateral positions. The arms are located on the base relative to one another such that the primary supporting surfaces confront one another so as to be arranged to clamp the object therebetween when both the first and second support arms are in the upright position.

### FIELD OF THE INVENTION

The present invention relates to a device for positioning an object upon which work is to be performed, and more particularly the present invention relates to a device for turning over an object supported thereon. The device is well suited for use in pairs in which an elongate object, for example a beam, is supported to span between the pair of devices such that the object may be turned over about a longitudinal axis generally extending between the pair of devices.

### BACKGROUND

In the manufacturing industry it is commonly desirable to reposition objects to be worked upon. When working upon elongate objects such as beams and the like, for welding or assembly and the like, it is known to support the object from a crane structure in which the object is supported at opposing ends on respective straps or chains in loops. The straps or chains are in turn supported on suitable mechanisms arranged to rotate them and in turn rotate the object supported thereon. As noted, the straps may comprise chains or any other flexible type member which can be supported in an annular configuration while suspending a heavy object therefrom. One example of such a device is disclosed in U.S. Pat. No. 4,114,765 belonging to Kojima. Use of such devices however typically requires a manufacturing facility having large overhead spaces and available equipment, for example overhead cranes and the like, and accordingly such a device is unsuitable for use in many applications.

Other devices relating generally to the field of positioning an object to be worked upon include U.S. Pat. No. 5,169,275 belonging to Kratz, U.S. Pat. No. 7,074,005 belonging to Nozawa et al., U.S. Pat. No. 6,540,472 belonging to Ewaschuk and U.S. Pat. No. 3,954,170 belonging to Schlough. Known examples of work positioning devices however are generally complex in configuration or are insufficient in ability to fully reposition the object to be worked upon through a range of positions sufficient for fully inverting the object. Furthermore, in many instances the complexity of the linkages or the pivoting connections between the components of the linkage are not well suited to supporting the large masses of large heavy beams thereon for example.

### SUMMARY OF THE INVENTION

According to one aspect of the invention there is provided a work positioning device for positioning an object to be worked on, the device comprising:

a base arranged to be supported on the ground;

first and second support arms, each having a primary supporting surface upon which the object is arranged to be supported, and each support arm being pivotally supported on the base for pivotal movement between an upright position in which the primary supporting surface extends generally upward in relation to the base and a lateral position in which the primary supporting surface extends generally laterally in relation to the base;

first and second actuators coupled between the base and the first and second support arms respectively so as to be arranged to displace the first and second support arms between the upright position and the lateral position respectively;

the first and second support arms being located on the base relative to one another such that the primary supporting surfaces confront one another so as to be arranged to clamp the object therebetween when both the first and second support arms are in the upright position.

By providing two support arms each having a surface arranged to support the object thereon and each being pivotal directly on a base between an upright position and a lateral position, the object can be readily supported on one of the arms in the lateral position, and then by bringing the arms together in the upright position, the object can be clamped between the arms to also be positioned upright, before subsequently being returned to a horizontal orientation supported on the other one of the support arms, having gone through a full 180° of rotation. The configuration of the work positioning device is simple and of low cost, while being suitable for inverting an object and supporting it in various orientations. When the devices are used in pairs, elongate objects such as large heavy beams can be supported to span a pair of the devices so that orientation of the beam can be manipulated about its respective longitudinal axis without the requirements of large overhead space and overhead cranes and the like as required by various prior art examples such as U.S. Pat. No. 4,114,765 to Kojima noted above.

Preferably both of the first and second support arms are pivotally supported directly on a fixed portion of the base.

The first and second support arms may be supported on the base for pivotal movement about a common pivot axis.

The primary supporting surface of each support arm may be arranged to be located substantially below a pivot axis of the support arm in the lateral position of the support arm.

Each of the support arms may be arranged to be pivoted in the respective upright position towards the other support arm past vertical opposite the respective lateral position.

When the device is in combination with another device of similar configuration and an elongate object spanning between devices, the actuators of corresponding ones of the support arms of the devices are preferably arranged to be commonly actuated between the respective lateral and upright positions of the support arm.

The first and second actuators are preferably operable independently of one another such that the first and second support arms are movable between the respective upright and lateral positions independently of one another.

When each of the first and second support arms include an inner end pivotally supported on the base and extend outwardly away from the other support arm to a free outer end in the respective lateral position of the support arm, the first and second actuators are preferably coupled to the first and second supports arms at a location spaced outwardly from the inner end. More preferably, the first and second actuators are coupled to the first and second support arms respectively adjacent the respective free outer ends of the first and second support arms.

Each support arm may further include an extension member supported on the free outer end of the support arm arranged to extend from the respective support arm away from the opposing support arm to an offset end when the support arms are supported in the upright position. In this instance, the first and second actuators being coupled to the offset ends of the first and second support arms respectively.

The first and second actuators are preferably coupled to the base spaced below a pivot axis of pivotal movement of the first and second support arms relative to the base.

When each of the first and second support arms is pivotally supported on the base adjacent an inner end and extends outwardly to an opposing free outer end, preferably each of the first and second support arms further comprises a secondary supporting surface adjacent the inner end which faces outwardly towards the free outer end of arm so as to be arranged to support the object thereon when the support arm is in the upright position.

Each secondary supporting surface is preferably movable together with the primary supporting surface of the respective support arm and is preferably oriented to lie generally perpendicular to the primary supporting surface of the respective support arm in both the upright position and the lateral position of the respective support arm.

The primary supporting surface of each support arm may comprise one of a plurality of primary supporting surfaces of different configuration relative to one another. In this instance, the plurality of primary supporting surfaces are preferably arranged to be interchangeably supported on each support arm.

Spacing between the primary supporting surfaces of the support arms in the upright position may be arranged to be adjustable by interchanging the primary supporting surface.

The base may be arranged to support each of the first and second support arms engaged thereon at a location spaced from pivotal connection of the respective support arm to the base when the support arm is in the respective lateral position.

In some embodiments, the primary supporting surface of each support arm comprise a straight edge spanning substantially a length of the support arm, in which the straight edges of the first and second support arms can be parallel and spaced apart from one another when both the first and second support arms are in the upright position.

The straight edge of each support arm may comprise an edge of a plate member projecting from the support arm.

In other embodiments, the primary supporting surface of each support arm comprises a pair of raised protrusions projecting upwardly from each support arm when the respective support arm is in the lateral position. Each pair of raised protrusions are preferably supported on the respective support arm at an adjustable lateral spacing relative to one another.

Each support arm may include a rail member spanning in a longitudinal direction of the support arm upon which the raised protrusions are slidably engaged. In this instance, preferably there is provided at least one fastener associated with each raised protrusion which is arranged to selectively secure the raised protrusion in position along the rail member.

One embodiment of the invention will now be described in conjunction with the accompanying drawings in which:

### BRIEF DESCRIPTION OF THE DRAWINGS

FIG. 1 is a perspective schematic view of a pair of the work positioning devices supporting a beam spanning therebetween.

FIG. 2 is a side elevational view of a work positioning device according to a first embodiment in which both of the support arms are in the upright position.

FIG. 3 is a side elevational view of the first embodiment of the device in which both of the support arms are in the lateral position.

FIG. 4, FIG. 5 and FIG. 6 are respective side elevational, end elevational and top plan views of the first embodiment of the device.

FIG. 7, FIG. 8 and FIG. 9 are respective side elevational, end elevational and top plan views of one of the support arms of the first embodiment of the device.

FIG. 10 and FIG. 11 are elevational and end views of the shaft of the device according to the first embodiment.

FIG. 12 and FIG. 13 are end and elevational views respectively of the collar supporting each of the support arms on the shaft of the device.

FIG. 14 and FIG. 15 are side elevational views of a second embodiment of the device in which both arms are shown in the upright position and in the lateral position respectively.

FIG. 16 is a perspective view of a further embodiment of the device.

FIG. 17 and FIG. 18 are side elevational views of the device according to FIG. 16 in which one of the arms is supported in the upright position before and after contraction of an auxiliary actuator respectively.

FIG. 19 is a perspective view of connection of the actuators to the base of the device according to FIG. 16.

In the drawings like characters of reference indicate corresponding parts in the different figures.

### DETAILED DESCRIPTION

Referring to the accompanying figures there is illustrated a work positioning device generally indicated by reference numeral 10. The device 10 is particularly suited for supporting an elongate object 12 upon which work is to be performed by positioning the object 12 to span across a pair of devices 10 of similar configuration. Although various embodiments are described and illustrated herein, the common features of all of the embodiments will first be described herein.

The device 10 is typically used in pairs in which each device includes a base 14 arranged to be fixed to the floor or to the ground at a location spaced apart from the other device 10 when the devices are used in pairs. Each base 14 includes a bottom plate 16 which is generally flat and rectangular, being elongate in a longitudinal direction of the base. Apertures are provided in the bottom plate 16 for bolting the base fixedly to the ground.

Two side plates 18 extend upwardly from opposing longitudinally extending sides of the bottom plate 16 so as to be generally centered relative to the longitudinal direction. The side plates 18 extend vertically upward from the opposing sides so as to be parallel and spaced apart from one another. First gusset plates 20 are joined with each side plate 18 to connect between the side plate 18 and opposed ends of the plate in the longitudinal direction. In addition second gusset plates 22 are provided to extend laterally outwardly from the outer sides of the side plates 18 to span between the side plates and the ground to reinforce the plates in the lateral direction.

Further reinforcing is provided in the lateral direction between the side plates by a central reinforcing member 24. The central reinforcing member generally comprises a tube of square cross section supported in an upright orientation and having a dimension which is snugly received between the side plates 18 to fully span between the inner sides of the side plates 18. The gusset plates and the reinforcing member are welded to the side plates 18 to form a generally unitary structure in which the side plates 18 extend vertically upward perpendicular to the floor to which the bottom plate 16 is fastened.

A shaft 26 is provided for connection between the two side plates 18 spaced above the central reinforcing member 24. The shaft 26 spans between the upper ends of the two side plates 18 and is centrally located in the longitudinal direction of the base. The shaft includes threaded bores at opposing end thereof for being fastened to the side plates 18 at opposing ends thereof. The shaft is fixed to extend in a horizontal orientation in which the longitudinal axis of the shaft 26 defines a pivot axis on the base 14.

First and second support arms 28 and 30 are supported on the base 14 for pivotal connection commonly on the shaft 26 about the common pivot axis defined by the shaft. Each of the first and second support arms includes an inner end 32 pivotally supported on the base. Each of the support arms also extends in a respective longitudinal direction of the arm to an outer end 34 comprising the free outer end of the generally elongate shape of the arm.

The support arms are each arranged to be independently pivotal about the common pivot axis between a respective upright position in which the longitudinal direction of the support arm extends generally vertically upward and a lateral position in which the support arm extends generally outwardly in a substantially horizontal orientation in a direction which is diametrically opposite that of the other support arm in its respective lateral position relative to the common pivot axis.

Each of the support arms 28 and 30 is generally L-shaped, defining an offset portion 36 extending radially outwardly from the common pivot axis, generally perpendicularly to the longitudinal direction of the support arm. A main portion 38 is also defined which is perpendicular to the offset portion 36 and extends substantially the full length of the support arm in the longitudinal direction to the free outer end 34. The first and second support arms 28 and 30 are located on the base 14 so that the two L-shaped support arms together form a generally U-shaped configuration when both main portions extend vertically upward due to the offset portions 36 extending radially outward from the common pivot axis in opposing directions. In this arrangement, the main portions 38 of the first and second supports arms are offset on opposing sides of the common pivot axis by the respective offset portions 36 so as to be parallel and spaced apart from one another when the support arms are both in the upright position.

The first and second support arms can be pivoted away from one another from the upright position towards the respective lateral positions in which the offset positions then extend generally downward from the common pivot axis while the main portions 28 extend generally horizontally outward opposite one another in the longitudinal directions of the respective support arms.

An inner side of the main portion of each support arm 28 and 30 defines a primary supporting surface 40 so that two primary supporting surfaces of the first and second support arms respectively confront one another while being oriented generally parallel and spaced apart when the two support arms are in the upright position. The primary supporting surfaces are thus arranged to support the object thereon in the lateral position as the primary supporting surfaces are oriented generally horizontal in this instance. When the two support arms 28 and 30 are pivoted into the upright position, the object is then arranged to be clamped between the confronting primary supporting surfaces 40.

The configuration of the offset portions 36 thus determines the amount of space between the confronting primary surfaces while also defining secondary supporting surfaces 42 on each support arm. The secondary supporting surfaces 42 are each fixed in relation to the respective primary supporting surface 40 so as to be moveable therewith. The secondary supporting surfaces 42 are each located adjacent the inner end 32 of the respective arm so as to be oriented perpendicularly to the primary supporting surface and the longitudinal direction of the arm to face outwardly towards the free outer end 34 of the respective arm. The secondary supporting surfaces 42 thus face upward when the support arms 28 and 30 are in the upright position so as to be arranged to support the object thereon when the arms are in the upright position.

The supporting surfaces are accordingly arranged so that in the lateral position of each of the first and second support arms 28 and 30, the secondary supporting surfaces 42 defined by the offset portion 36 of each arm extend generally downward from the common pivot axis in a generally vertical configuration while the primary supporting surfaces are oriented to extend generally horizontally and laterally outwardly near or below the common pivot axis. Alternatively in the upright position of each of the first and second support arms 28 and 30, the secondary supporting surfaces 42 are oriented generally horizontally to extend laterally outwardly from opposing sides of the common pivot axis while the primary supporting surfaces 40 extends upwardly in a generally vertical orientation parallel and spaced apart from one another on opposing sides of the common pivot axis.

In each embodiment, at least one collar 44 is provided for mounting each of the first and second support arms to the common shaft 26. The collars 44 are arranged to have an inner diameter which closely matches the outer diameter of the shaft 26 for rotatable engagement thereon. The collars associated with each arm 28 and 30 are offset from one another in the longitudinal direction of the shaft along the pivot axis so that the corresponding support arms 28 and 30 are also offset from one another in the axial direction of the pivot axis so that the inner ends of the support arms are permitted to rotate past one another about the common shaft. Passages 46 are provided through the shaft and in communication with the location of each one of the collars 44 for communication with a grease fitting at one end of the shaft to readily insert grease between each collar 44 and the shaft to lubricate relative rotation therebetween.

A first actuator 48 and a second actuator 50 are provided for communication between the first and second support arms 28 and 30 and the base 14 respectively. The first and second actuators 48 and 50 are operable independent of one another so that the first and second support arms 28 and 30 associated therewith respectively are independently moveable between the respective upright and lateral positions.

Each of the first and second actuators includes a cylinder end 52 secured to the base so that the two cylinder ends 52 are located spaced apart in the longitudinal direction of the base relative to one another, near the center of the base, below the pivot axis. The mounting locations of the cylinder ends 52 of the actuators are arranged to be offset from one another in a lateral or axial direction of the common pivot axis to correspond with the axial offset of the first and second supports arms to which the first and second actuators are respectively coupled.

Each actuator is arranged to extend generally upward and outward to be coupled at a rod end 54 pivotally on the free outer end 34 of the respective one of the first and second support arms 28 and 30. Each support arm includes an extension member 56 located at the free outer end which extends outwardly generally perpendicular to the longitudinal direction of the support arm outward and away from the other one of the support arms when the two support arms are supported in the upright orientation. Each extension member extends away from the opposing support arm to an offset end 58 pivotally coupling the respective one of the first and second actuators thereon at the rod end 54.

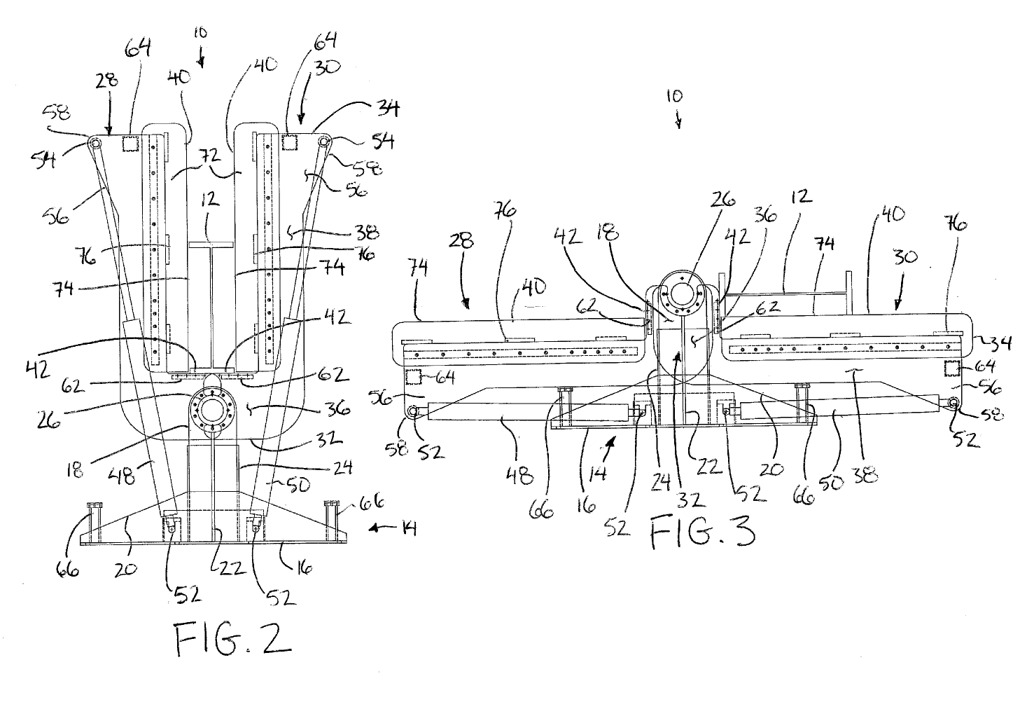

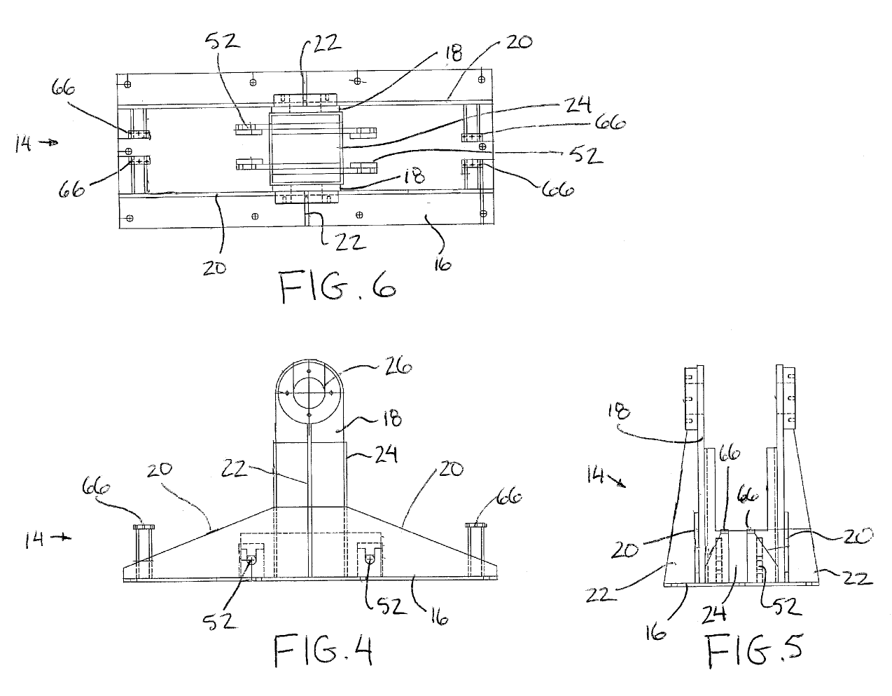

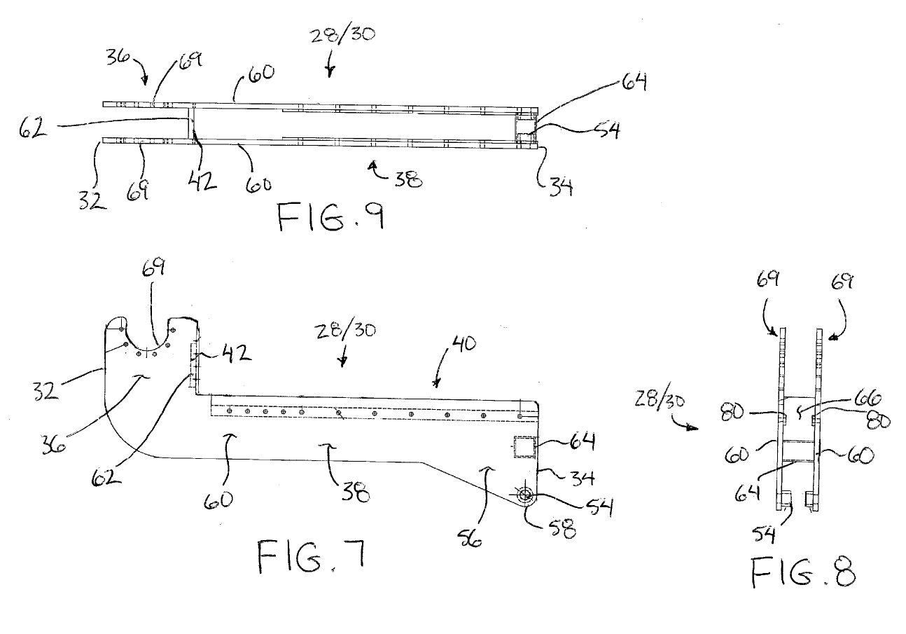

As illustrated in FIG. 2, the extension member 56 supports the first and second actuators to extend at an outward angle sufficiently far from the common shaft 26 that there is no interference between the actuators and the shaft. In this arrangement each of the support arms is thus arranged to be pivoted beyond the upright position towards the other support arm past a vertical orientation in a direction of rotation opposite the direction of rotation towards the respective lateral position of that support arm. This configuration is particularly suited for providing a clamping force between the confronting primary supporting surfaces of the support arms to clamp the object being supported by the device between the confronting primary supporting surfaces.

In the illustrated embodiments, each of the supports arms 28 and 30 comprises a pair of parallel plates 60 extending substantially the full length of the support arm along both the offset portion 36 and the main portion 38. The two plates 60 defining each support arm are fixedly maintained in a parallel and spaced apart configuration by a first support member 62 spanning between the plate 60 adjacent the inner end of the main portion of the arms and by a second support member 64 extending between the plate 60 adjacent the outer end thereof. The first support member 62 spans between the plates 60 at the offset portion 36 and assists in defining the secondary supporting surface 42 of each support arm. The second support member 64 at the outer end of each arm comprises a section of steel tube of square cross section.

The base 14 is arranged to support both of the first and second support arms 28 and 30 engaged thereon at a location which is spaced outwardly from the common pivot axis when both of the first and second support arms are in the lateral position. This is accomplished by a pair of legs 66 provided at both longitudinally opposed ends of the base 14 which extend upwardly from the bottom plate 16 a height which is arranged so that the top end of each leg 66 abuts a respective one of the plates 60 of the respective one of the first and second support arms 28 and 30 when the support arms are oriented with the main portions 38 extending horizontally in the lateral position so that the primary supporting surfaces are also general horizontal.

Each of the first and second actuators 48 and 50 are hydraulically actuated by a controller 68. One controller 68 is provided for each pair of devices 10 of identical configuration. The controller 68 is arranged so that the corresponding first support arms 28 of the two devices are linked for common actuation together between the respective upright and lateral positions while the second support arms 30 of the two devices 10 are also linked for common actuation between the upright and lateral positions thereof. Within each pair, the first support arm and the second support arm are actuated independently of one another.

The devices 10 are each provided with a plurality of primarily supporting surfaces which are different in configuration relative to one another, in which all of the primary supporting surfaces can be interchangeably supported on each support arm. For example, in the first embodiment of FIG. 2 and the second embodiment of FIG. 14, all of the components of the first and second support arms, the base 14 and the first and second actuators are identical to one another, however the primary supporting surfaces supported on the support arms are different in configuration from one another and interchangeable relative to one another.

In each instance, the primary supporting surface is selectively attached to the support arm using threaded fasteners for ready separation and reattachment thereof as desired. Each of the support arms 28 and 30 includes a plurality of fastener apertures at spaced positions in the longitudinal direction along the main portion 38 thereof. The fastener holes permit one or more primary supporting surfaces to be supported at an adjustable spacing in a lateral direction relative to the longitudinal direction of the support arm to adjust a relative spacing between the confronting primary supporting surfaces of two support arms in the upright position depending upon the configuration of the primary supporting surface used, or alternatively as shown in the second embodiment, the primary supporting surface may comprise a plurality of separate segments which are supported at an adjustable spacing in the longitudinal direction of the support arm relative to one another.

Turning now more particularly to the first and second embodiments, the mounting of the collars 44 on the shaft 26 will now be described in further detail. In this instance, the inner ends of each of the plates 60 includes a semi-circular recess formed therein which closely matches the diameter of the collars 44 for receiving one of the collars 44 within the semi-circular recess at the end of each plate 60 of each of the first and second support arms 28 and 30. Accordingly two collars are provided for mounting each of the support arms on the shaft. Each collar 44 in this instance includes a radially projecting flange 70 extending partway about a circumference of the collar which locates bolt apertures therein for alignment with corresponding bolt apertures within each of the plates 60 about the semi-circular recess 69 receiving the collar therein.

With the inner ends of the plates 60 of the support arms 28 and 30 being fastened to the collars, the collars slidably receive the shaft 26 therethrough so that the collars are aligned in series with one another along the shaft in abutment with one another and with suitable spacers therebetween to maintain a proper offset relationship of the first and second support arms in the axial direction. The collars of the two support arms are mounted in an alternating configuration so that one collar 44 and corresponding plate 60 mounted thereon is received between the pair of collars 44 and respective plates 60 of the opposing support arm.

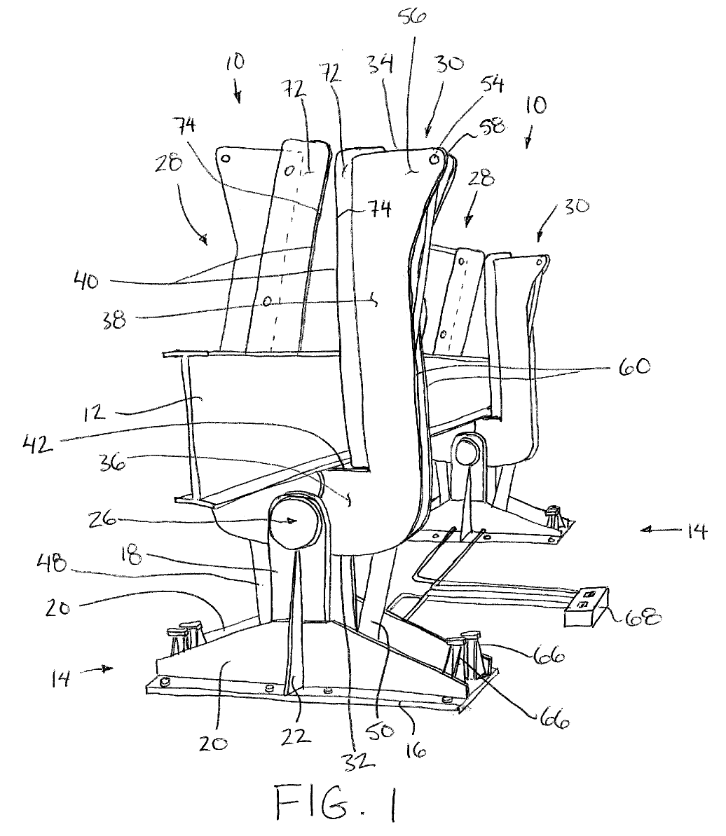

Turning now more particularly to the first embodiment of FIGS. 1 though 13, the primary supporting surfaces in this instance comprise plates 72 defining a straight edge 74 along the inner side thereof which extends along the full length of the support arm parallel to the longitudinal direction thereof and spaced inwardly in relation to the inner side of the support arm. The two plates 72 defining the primary supporting surfaces are supported on one of the plates 60 defining each of the first and second support arms 28 and 30 and are oriented relative to the arm so that when the two support arms are in the upright position, the straight edge 74 at the inner side of each plate, defining the primary supporting surface thereon, remains parallel and spaced apart from the primary supporting surface of the opposing support arm. The object is thus clamped between the straight edges 74 along the inner sides of the two plates 72.

Each plate 72 includes a plurality of lugs 76 projecting generally in the longitudinal direction along one side thereof for engagement with the inner side edge of the respective support arm. The lugs are positioned so that when the support arms are in the lateral position and the main portions of the arms extend generally horizontally, the lugs 76 are engaged on the top side of the main portions of the support arms respectively so that any weight of the objects resting on the straight edge 74 of the plates 72 is transmitted through the lugs 76 to be in turn carried on the inner sides of the main portions of the respective support arms. Fastener holes are provided at spaced locations along the plates 72 for maintaining the lugs 76 engaged with the inner side edge of the support arms. The straight edge 74 defining the primary supporting surface is thus arranged to be spaced upwardly from the inner side edge of the support arms when the support arms are in the lateral position. Accordingly replacing the plates 72 with plates having a different spacing between the straight edge 74 thereof and the lugs 76 will affect the space between the straight edge 74 and the support arm which in turn affects the spacing between the confronting primary supporting surfaces when the arms are in the upright position.

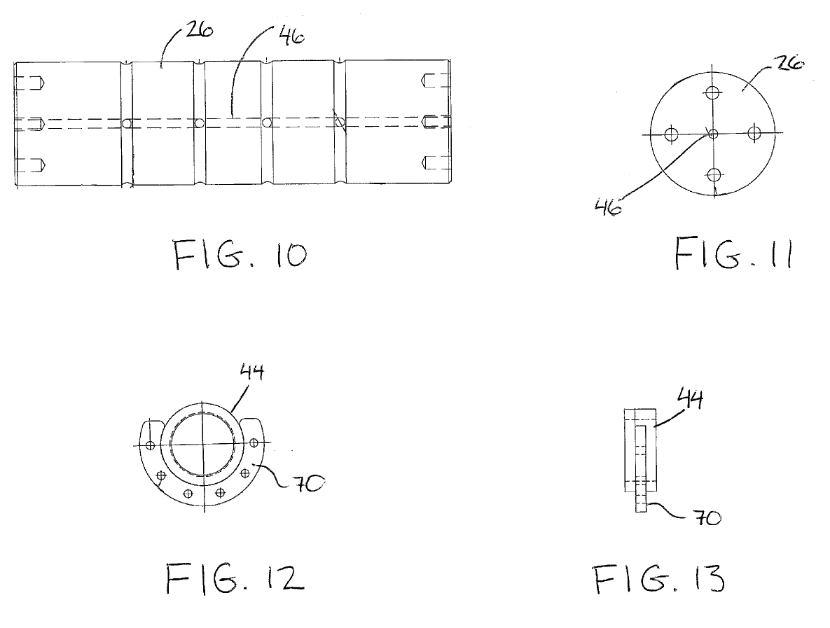

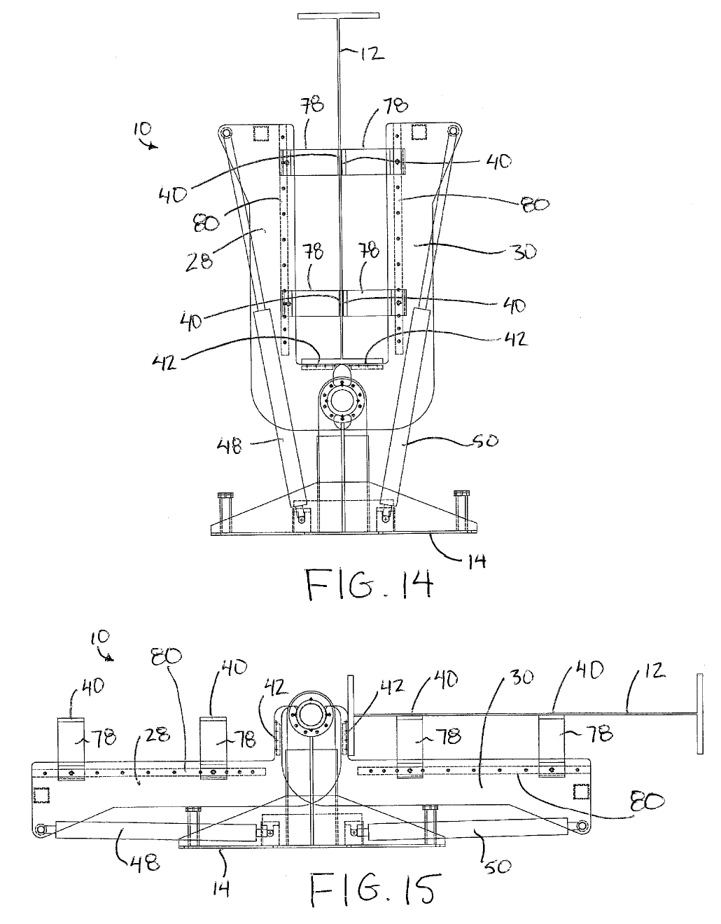

Turning now to the second embodiment shown in FIGS. 14 and 15, each primary supporting surface in this instance is instead defined by a pair of blocks 78 mounted between the parallel plates 76 of each of the first and second support arms 28 and 30. Each block 78 is fastened by threaded fasteners to both of the parallel plates 60 to extend inwardly towards the opposing support arm in relation to the inner side of the main portion of the support arm in the upright position. In this instance each block 78 defines a raised protrusion in relation to the body of the support arm so that the outer free end of each block 78 defines one segment of the primary supporting surface in which the primary supporting surfaces again confront one another when the two support arms are supported in the upright position. By arranging height of the protrusions or blocks 78 relative to the main portion of the support arms, to be near to the offset of the offset portions 36 of the support arms, the primary supporting surfaces of the two support arms 28 and 30 are arranged to be near one another for nearly engaging one another in the upright positions of the support arms as shown in FIG. 14. The blocks 78 defining the primary supporting surfaces in this instance are suitably arranged for clamping the thin web of an I-beam therebetween, or a thin plate member and the like when used for supporting other objects.

In order to provide further support to the blocks 78 when the arms are in the lateral position, rails 80 are provided to extend in the longitudinal direction along the inner sides of the parallel plates 60 respectively of each of the first and second support arms 28 and 30. The rails 80 comprise a raised rib which is parallel to and spaced from the inner side edge of the main portion of each support arm so that an inner bottom end of each block 78 may be abutted against the rail for sliding engagement therealong. The row of fastener apertures located spaced along each of the support arms is arranged to be spaced between the rail 80 and the inner side edge of each plate 60 along the main portion of each support arm 28 and 30. In this arrangement, the rails 80 bear the weight of the blocks and the objects supported thereon when the arms extend laterally outward in the lateral position, while the fasteners received through cooperating apertures in the plates 60 and the blocks 78 serve primarily to fix the longitudinal position of the blocks along the support arms. In this arrangement the longitudinal position of each block and the relative spacing therebetween, on each of the first and second support arms, is readily adjustable.

When comparing the first and second embodiments, the configuration of the plates 72 defining the primary supporting surfaces is particularly useful when supporting objects having a widest dimension which is less then an overall height of the support arms in the upright position. When supporting an I-beam for example, when the length of the web is less than the length of the support arms, the upper and lower flanges of the I-beam can both be received at spaced positions along the primary supporting surfaces for readily clamping the beam therebetween. Alternatively when supporting an awkward shaped object which is longer than the height of the support arms, for example an I-beam having a web which is longer than the support arms, the blocks 78 may be instead be used for clamping the web of the beam therebetween so that one of the flanges is located in abutment on the secondary supporting surfaces while the other flange of the I-beam is spaced above the device when the support arms are in the upright position.

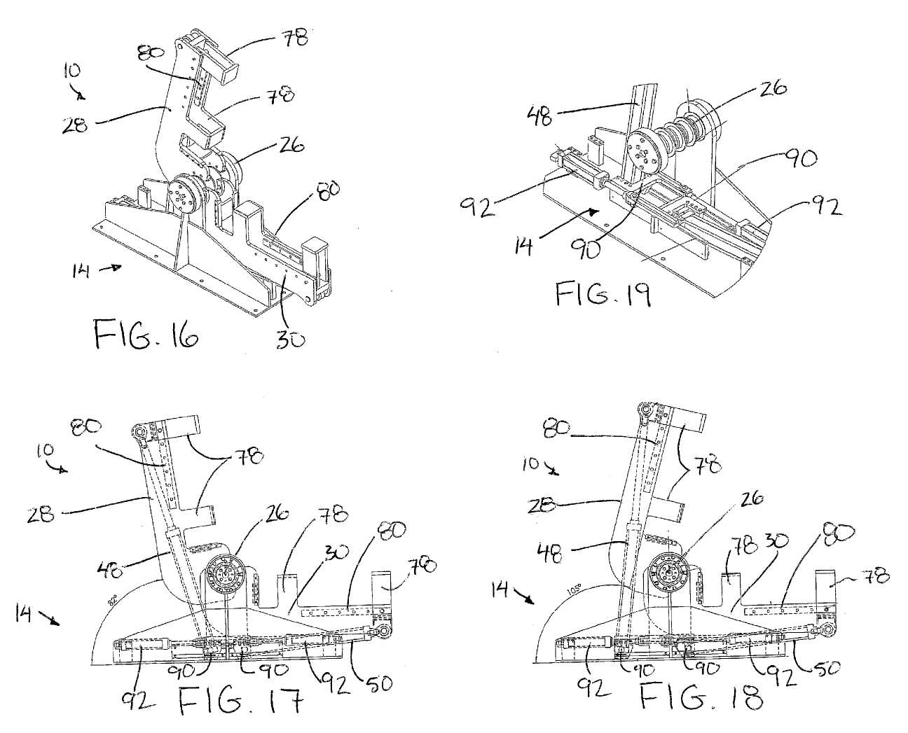

Turning now to the third embodiment shown in FIGS. 16 through 19, a configuration of blocks 78 may be used similar to the previous embodiment, but where an inner most one of each pair of blocks on each support arm, which is nearest the inner end of the support arm, is integrally formed with the plates 60 forming the support arm so that only one of the blocks is slidably adjustable along the rails at one of numerous positions to be fixed relative to the other block.

The third embodiment also differs in that the extension member has a lesser degree of offset in relation to the inner side of the support arm. Accordingly when it is desired to rotate one of the support arms beyond the upright position, past vertical towards the other support arm is shown in FIG. 18, interference between the respective actuator and the shaft can instead be prevented by supporting the cylinder end of the actuator on a slide 90 which is slidably displaceable in the longitudinal direction of the base in relation to the bottom plate of the base. In this arrangement an auxiliary actuator 92 is coupled between each slide 90 supporting the cylinder end of a respective one of the actuators thereon and the base 14. In this embodiment, the cylinder ends are initially located adjacent one another beneath the common pivot axis. Movement of the support arms from the lateral position to a position approaching the upright position is accomplished only by the first and second actuators as in the previous embodiment. However when approaching the upright position, the third embodiment differs from the previous embodiments in that the auxiliary actuator 92 associated with each support arm is actuated to displace the cylinder end of the respective first and second actuators outward in the longitudinal direction to increase the extension of the respective one of the first and second actuators which in turn rotates the respective one of the support arms passed vertical to an over center position as shown in FIG. 18.

Use of the device is accomplished in a similar manner in all embodiments of the present invention. Two devices 10 of identical configuration are located at spaced apart positions with the common pivot axes thereof aligned with one another to be substantially coaxial. The first support arms are initially positioned horizontally in the lateral position with an elongate beam engaged thereon spanning between the two devices. The first support arms can then be actuated towards the upright position to initially raise and rotate the beam through 90 degrees about its respective longitudinal axis. At this point the second support arms of the two devices can be commonly actuated to also be displaced into the upright position whereby the beam is clamped between the confronting primary supporting surfaces of the first and second support arms of both devices. To fully invert the beam to be rotated 180 degrees about its respective longitudinal axis, the second support arms can then be actuated back the their lateral position while the first support arms cease to support the beam. The weight of the beam is initially carried on the primary supporting surface of the first support arms in the lateral position. As the support arms are displaced to the upright position, the weight of the beam is then transferred to the secondary support surfaces of both support arms until the second support arms are again lowered to the lateral position while carrying the beam thereon, at which point, once the lateral position is reached, the beams are fully supported on the primary supporting surfaces of the second support arms.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A work positioning device for positioning an object to be worked on, the device comprising:
a base arranged to be supported on the ground;
first and second support arms, each having a primary supporting surface upon which the object is arranged to be supported, and each support arm being pivotally supported on the base for pivotal movement between an upright position in which the primary supporting surface extends generally upward in relation to the base and a lateral position in which the primary supporting surface extends generally laterally in relation to the base;
first and second actuators coupled between the base and the first and second support arms respectively so as to be arranged to displace the first and second support arms between the upright position and the lateral position respectively;
the first and second support arms being located on the base relative to one another such that the primary supporting surfaces confront one another so as to be arranged to clamp the object therebetween when both the first and second support arms are in the upright position.

2. The device according to claim 1 wherein both of the first and second support arms are pivotally supported directly on a fixed portion of the base.

3. The device according to claim 1 wherein the first and second support arms are supported on the base for pivotal movement about a common pivot axis.

4. The device according to claim 1 wherein the primary supporting surface of each support arm is arranged to be located substantially below a pivot axis of the support arm in the lateral position of the support arm.

5. The device according to claim 1 wherein each of the support arms is arranged to be pivoted in the respective upright position towards the other support arm past vertical opposite the respective lateral position.

6. The device according to claim 1 in combination with another device of similar configuration and an elongate object spanning between devices, the actuators of corresponding ones of the support arms of the devices being arranged to be commonly actuated between the respective lateral and upright positions of the support arm.

7. The device according to claim 1 wherein the first and second actuators are operable independently of one another such that the first and second support arms are movable between the respective upright and lateral positions independently of one another.

8. The device according to claim 1 wherein each of the first and second support arms includes an inner end pivotally supported on the base and extends outwardly away from the other support arm to a free outer end in the respective lateral position of the support arm, the first and second actuators being coupled to the first and second supports arms at a location spaced outwardly from the inner end.

9. The device according to claim 8 wherein the first and second actuators are coupled to the first and second support arms respectively adjacent the respective free outer ends of the first and second support arms.

10. The device according to claim 9 wherein each support arm has an extension member supported on the free outer end of the support arm arranged to extend from the respective support arm away from the opposing support arm to an offset end when the support arms are supported in the upright position, the first and second actuators being coupled to the offset ends of the first and second support arms respectively.

11. The device according to claim 1 wherein the first and second actuators are coupled to the base spaced below a pivot axis of pivotal movement of the first and second support arms relative to the base.

12. The device according to claim 1 wherein each of the first and second support arms is pivotally supported on the base adjacent an inner end and extends outwardly to an opposing free outer end and wherein each of the first and second support arms further comprises a secondary supporting surface adjacent the inner end which faces outwardly towards the free outer end of arm so as to be arranged to support the object thereon when the support arm is in the upright position.

13. The device according to claim 12 wherein each secondary supporting surface is movable together with the primary supporting surface of the respective support arm and is oriented to lie generally perpendicular to the primary supporting surface of the respective support arm in both the upright position and the lateral position of the respective support arm.

14. The device according to claim 1 wherein the primary supporting surface of each support arm comprises one of a plurality of primary supporting surfaces of different configuration relative to one another and wherein the plurality of primary supporting surfaces are arranged to be interchangeably supported on each support arm.

15. The device according to claim 1 wherein spacing between the primary supporting surfaces of the support arms in the upright position is arranged to be adjustable.

16. The device according to claim 1 wherein the base is arranged to support each of the first and second support arms engaged thereon at a location spaced from pivotal connection of the respective support arm to the base when the support arm is in the respective lateral position.

17. The device according to claim 1 wherein the primary supporting surface of each support arm comprise a straight edge spanning substantially a length of the support arm, the straight edges of the first and second support arms being parallel and spaced apart from one another when both the first and second support arms are in the upright position.

18. The device according to claim 17 wherein the straight edge of each support arm comprises an edge of a plate member projecting from the support arm.

19. The device according to claim 1 wherein the primary supporting surface of each support arm comprises a pair of raised protrusions projecting upwardly from each support arm when the respective support arm is in the lateral position, each pair of raised protrusions being supported on the respective support arm at an adjustable lateral spacing relative to one another.

20. The device according to claim 19 wherein each support arm includes a rail member spanning in a longitudinal direction of the support arm upon which the raised protrusions are slidably engaged and wherein there is provided at least one fastener associated with each raised protrusion which is arranged to selectively secure the raised protrusion in position along the rail member.
